(19) United States
(12) Patent Application Publication
(10) Pub. No.: US 2011/0150739 A1
(43) Pub. Date: Jun. 23, 2011

(54) METHOD FOR REMOVING BORON-CONTAINING IMPURITIES FROM HALOGEN SILANES AND APPARATUS FOR PERFORMING SAID METHOD

(75) Inventors: Beate Seliger, Neu Wulmstorf (DE); Norbert Schladerbeck, Kelkheim (DE); Ingo Pauli, Schmitten (DE); Andre Mecklenburg, Radebeul (DE); Reinhold Schork, Rheimfelden (DE); Hartwig Rauleder, Rheinfelden (DE); Frank Kropfgans, Rheinfelden (DE); Joachim Diefenbach, Rheinfelden (DE)

(73) Assignee: Evonik Degussa GmbH, Essen (DE)

(21) Appl. No.: 12/999,240

(22) PCT Filed: Apr. 23, 2009
(86) PCT No.: PCT/EP2009/054877

§ 371 Date: Mar. 4, 2011

(30) Foreign Application Priority Data
Jun. 19, 2008 (DE) 10 2008 002 537.2

(51) Int. Cl. C01B 33/08; B01D 3/34; B01D 3/02

(52) U.S. Cl. 423/341; 203/32; 202/173; 202/155

(57) ABSTRACT

The invention relates to a method for reducing the content of boron-containing compounds in compositions I comprising at least one silicon halide, especially of chlorosilanes of the type HnSiCI4-n with n being equal to 0, 1, 2 or 3, by introducing a small amount of moisture into the composition I in a first step and separating the hydrolyzed boron- and/or silicon-containing compounds in a second step in such a way that a pre-purified composition II having a reduced boron content is obtained, wherein, in particular, the first and second steps can be run in at least one or more cycles. Also claimed is an apparatus for performing the method and an overall system into which this apparatus is integrated.

The invention relates to a process for reducing the content of boron-containing compounds in compositions I comprising at least one silicon halide, especially chlorosilanes of the HₙSiCl₄₋ₙ type where n is 0, 1, 2 or 3, by introducing a small amount of moisture into the composition I in a first step, and removing the hydrolyzed boron- and/or silicon-containing compounds in a second step to obtain a prepurified composition II with a reduced boron content; more particularly, the first and second steps can be conducted in at least one or more than one cycle. Also claimed is a plant for performing the process, and an overall plant into which this plant is integrated.

Halosilanes, and particularly chlorosilanes such as monochlorosilane, dichlorosilane, trichlorosilane and tetrachlorosilane, are important intermediates in the production of ultrapure silicon for the semiconductor industry, of monosilane SiH₄ for the photovoltaics industry, in the further conversion to organofunctional silanes, such as adhesion promoters, or else for production of high-purity SiO₂ for production of light waveguides or for the pharmaceutical industry. Common to all industrial applications are the very high purity requirements on the halosilanes to be converted, the impurities of which may be at most in the region of a few mg/kg (ppm range), and in the semiconductor industry in the region of a few μg/kg (ppb range).

To prepare crude chlorosilanes, metallurgical silicon is hydrochlorinated. The reaction is generally accomplished in a fluidized bed reactor or in a fixed bed reactor; a rarer case is a reaction in a tubular furnace (inter alia B. Kanner and K. M. Lewis “Commercial Production of Silanes by the direct Synthesis”, pages 1 to 66, Studies in Organic Chemistry 49, Catalyzed Direct Reactions of Silicon edited by K. M. Lewis and D. G. Rethwisch, 1993, Elsevier Science Publishers; DE 36 40 172 Cl; W. C. Breneman et al., “A comparison of the trichlorosilane and silane routes in the purification of metallurgical grade silicon to semiconductor quality”, Silicon for the chemical industry IV, Geiranger, Norway, Jun. 3-5, 1998, pages 1001 to 112).

Alternatively, the preparation can also be effected by reaction of tetrachlorosilane with metallurgical silicon and hydrogen chloride (H. Samori et al., “Effects of trace elements in metallurgical silicon on trichlorosilane synthesis reaction”, Silicon for the chemical industry III, Sandefjord, Norway, Jun. 18-20, 1996, pages 157 to 167). In the presence of hydrogen, the yield of trichlorosilane in the reaction can be enhanced.

Additionally known for enhancing the yield of trichlorosilane are processes for hydrodehalogenation of silicon tetrachloride in the presence of hydrogen over catalysts. The catalysts used may be unsupported or supported catalysts based on transition metals or transition metal compounds.

A common feature of the processes is that some of the impurities introduced via the metallurgical silicon converted are likewise chlorinated and can also be entrained into downstream processes. The iron-, copper-, aluminum- and manganese-based impurities can generally be removed substantially completely from the chlorosilane compounds by distillation steps. However, the halogenated arsenic, phosphorus and boron compounds have similar physicochemical properties to the chlorosilanes, and can therefore be removed therefrom only insufficiently by means of distillative separation processes. The boron originating from the metallurgical silicon is likewise hydrochlorinated under the reaction conditions which exist. The boron trichloride (BCl₃) formed in particular cannot be removed from trichlorosilane and dichlorosilane by distillation owing to the close proximity of the boiling points of the compounds. Any residual moisture present within a process can then lead to the formation of partial hydrolyzates of boron trichloride.

A problem with pentavalent phosphorus and arsenic is, for example, the doping that they cause of the silicon produced as an n-type semiconductor. Trivalent boron likewise leads to unwanted doping of the silicon produced, such that a p-type semiconductor is obtained. Particular difficulties are caused by contamination of the halosilanes with boron-containing compounds, because boron in the silicon melt and in the solid phase has a partition coefficient of 0.8 and is therefore virtually impossible to remove from the silicon by zone melting (DE 2 546 957 A1). For this reason, the aim is boron contents of below 0.05 mg/kg (ppm by weight), preferably of below 5 μg/kg (ppb by weight), in halosilanes and especially in chlorosilanes.

The prior art discloses various processes for removal of boron-containing impurities. For example, a removal of boron-containing impurities can be effected by adsorption on silicas from gaseous trichlorosilane, as disclosed in U.S. Pat. No. 4,713,230. The adsorbents used are silica gels having a hydroxyl group content of 1 to 3% by weight, the content of which has been determined by means of titration with lithium aluminum di-n-butyl-amide. To reduce the boron content, the trichlorosilane is passed in gaseous form through a column containing adsorbent. According to the processes of U.S. Pat. No. 4,731,230, the boron content can be reduced to, for example, below 150 ppba. As a result of the high inlet concentrations of boron trichloride in the gaseous trichlorosilane stream, however, the loading capacity of the adsorbent has been attained when boron contents of 150 ppba are found in the trichlorosilane stream. A disadvantage of this process is therefore the resulting short service life of the adsorbent as a result of rapid exhaustion of the loading capacity. The loading capacity can be found via the determination of the breakthrough curve.

German published specification 2 546 957 Al teaches a process in which halosilanes present in the liquid phase are treated using hydrated oxides or silicates with a water content of 3 to 8% by weight, where the latter should not comprise any complex-bound water. The high-boiling boron complexes are adsorbed on the silicates, while boron trichloride is hydrolyzed and complexed. The high-boiling boron complexes, some of which distill over with liquid trichlorosilane, are subsequently drawn off in the column bottoms in a warm water distillation of the trichlorosilane.

A common feature of both processes is the rapid attainment of the loading capacity of the adsorbents used. These adsorption systems are therefore uneconomic. This results from the short service lives of the adsorbents, which require a frequent exchange of the adsorbent and an interruption of the process. Secondly, the plants would have to be designed with a very large volume in order to prolong the short service lives to some degree. In addition, the processes mentioned are usually attuned specifically to the trichlorosilane stream, or integrated upstream or downstream of the distillation unit of an overall process for chlorosilane production. Variations in the boron content in the chlorosilane stream, for example in the case of increasing loading of the adsorbent, upstream of the distillation unit therefore continue directly in the separated product streams (dichlorosilane, trichlorosilane and/or tetrachlorosilane).

The prior art further discloses reducing the level of boron-containing compounds in chlorosilanes by contacting them with moist inert gas (DD 158322). The reactions include those of the chlorosilanes with the water present, and of the products in turn with the boron trichloride, which convert it to comparatively nonvolatile boron compounds which can be removed by distillation.

German published specification DE 1 906 197 discloses a process in which water vapor or a water-saturated nitrogen stream reacts with vaporous chlorosilanes to give partially hydrolyzed chlorosilanes which are dispersed in liquid chlorosilanne, then the partially hydrolyzed chlorosilanes and the boron-containing compounds are removed.

A disadvantage of this procedure are the large amounts of water required for complete reaction of the boron trichloride with water. Even though the boron compounds react more rapidly with water than the silanes, full removal of the boron-containing compounds requires a large molar excess of water. In the case of complete removal of boron-containing compounds, these amounts of water lead to persistent silicification of the plant as a result of the formation of SiO₂ and polymeric siloxanes, and to large amounts of corrosive hydrogen chloride. Both lead to increased material stress on the production plants. In the case of a reaction regime with customary reaction times and acceptable addition of water, the boron contents in the chlorosilanes obtained are above the limits of the specifications for production of solar silicon or semiconductor silicon. The silicon qualities to be obtained via this process are, according to WO 2006/054325 A2, at a specific resistivity of 100 Ω·cm for p-type semiconductors.

It is an object of the present invention to provide an economically viable process for virtually quantitative removal of boron-containing compounds, wherein the boron-containing compounds should already be removed before the distillative separation or in the foremost part of the distillative separation of the halosilane product mixture, especially of the chlorosilane product mixture comprising tetrachlorosilane, trichlorosilane, dichlorosilane and/or monochlorosilane, such that constantly low boron contents are ensured over all product streams, especially of less than 0.05 mg/kg; in addition, it should be possible to integrate the process according to the invention in a simple manner into a continuous process for producing ultrapure halosilanes, such as ultrapure chlorosilanes, proceeding from metallurgical silicon.

The object is achieved by the process according to the invention and the inventive plant according to the features of claims 1 and 37, preferred embodiments being detailed in the dependent claims.

The process according to the invention divides into at least two process steps. The invention provides a process for reducing the boron content, especially of boron-containing compounds, in compositions I comprising at least one silicon halide
in which, in a first step, the composition I is contacted with up to 600 mg of moisture per kilogram of the composition I (1), especially with 0.5 to 500 mg/kg (ppm), preferably with 5 to 100 mg/kg (ppm), more preferably with 10 to 50 mg/kg (ppm), and
the composition I (1.1) from the first step, which has been contacted with moisture, is optionally supplied at least once, preferably more than once, completely or partially, to a component step (2a) for removing hydrolyzed boron- and/or silicon-containing compounds to obtain a prepurified composition IIa_{1→4}, (1.2), which is completely or partially fed back to the first step or to a second step of the process,
wherein, in the second step, hydrolyzed boron- and/or silicon-containing compounds are removed by distillation (2) to obtain, as a distillate, a prepurified composition II (2.1.1) with a reduced boron content; more particularly, the prepurified composition II, optionally after a condensation step (2.2), can be contacted in a third process step with a moist adsorbent (3) to obtain a prepurified composition III (3.1); the latter can preferably be supplied to a fine distillation (4) in order to isolate at least one ultrahigh-purity silicon compound.

The invention also provides a composition III obtainable by the process according to the invention, and also an ultrahigh-purity silicon compound obtainable by the process according to the invention.

According to the invention, the prepurified composition II or a prepurified composition III are converted or used to prepare at least one ultrahigh-purity silicon compound. Ultrahigh-purity silicon compounds include ultrahigh-purity halosilanes such as HₚSiₘHal_{[(2m+2)-p]} where m=1 to 6, p=1 to 13, Hal=Cl, Br and/or I, silanes such as HₙSi₂ₙ₊₂ where n=1 to 12 and/or else silicon nitride, silicon oxynitride, silicon dioxide, but also silicon, especially silicon suitable for photovoltaics or the semiconductor industry. The ultrahigh-purity silicon compounds mentioned preferably have a maximum contamination per element or compound of ≦0.05 mg/kg (ppm), preferably of ≦5 μg/kg (ppb), especially of ≦1 μg/kg (ppb).

A composition I comprising at least one silicon halide is understood in accordance with the invention to mean compositions obtainable from processes comprising a hydrochiorination or hydrohalogenation of metallurgical silicon, optionally with subsequent removal of solid constituents and especially a subsequent scrubbing and/or quenching of these reaction products. The composition I preferably comprises tetrachlorosilane, trichlorosilane, dichlorosilane and/or monochlorosilane, especially as a mixture. Alternatively, it comprises halosilanes such as tetrabromosilane, tribromosilane, or else mixed halosilanes. As stated at the outset, as a result of the starting materials, the elements present therein are also partly hydrohalo-genated; a composition I therefore always also comprises a content of impurities, especially of boron-containing impurities, such as boron trichloride or partial hydrolyzates of boron trichloride, which form as a result of residual moisture.

The composition I contacted with moisture relates to a composition I which has been contacted for the first time with moisture supplied separately; for example, a composition I resulting from a hydrohalogenation of metallurgical silicon has been contacted with up to 600 mg of moisture per kilogram of composition I, preferably with 5 to 100 mg/kg (ppm), more preferably with 10 to 50 mg/kg (ppm).

The separately supplied moisture does not include the moisture entrained from preceding process steps, nor the moisture which can be entrained into the first process step from a complete or partial recycling of the prepurified composition IIa_{1→∝}. The moisture is supplied especially via an inert gas, such as nitrogen, argon and/or hydrogen. For this purpose, liquid water, preferably demineralized water, is typically homogenized together with the inert gas at elevated temperature, and especially heated to more than 100° C. with complete freedom from droplets. The resulting heated moist inert gas is then introduced into the composition I under elevated pressure. The moisture is preferably fed in with nitrogen as the carrier gas.

The composition I which has been contacted with moisture is preferably at least once fed completely or partially, “partially” relating to 5 to 95% by weight, preferably to 50 to 95% by weight, more preferably to 75 to 95% by weight, to a component step for removal of hydrolyzed boron- and/or silicon-containing compounds to obtain a prepurified composition IIa_{1→∝}, which is fed completely or partially, “partially” relating to 5 to 95% by weight, preferably to 50 to 95% by weight, more preferably to 75 to 95% by weight, back to the first step or a second step of the process. In general, the hydrolyzed boron-containing compounds are removed by distillation.

A prepurified composition IIa_{1→∝} refers to a composition IIa which has passed through this component step in at least one cycle. Owing to mixing of the compositions in the case of recycling into process steps one and/or two, substreams of the composition may pass through the component step more than once; this is what is supposed to be expressed by the expression composition IIa_{1→∝}.

In a second process step, hydrolyzed boron- and/or silicon-containing compounds are removed by distillation to obtain, as a distillate, a prepurified composition II with a reduced boron content.

“Distillative removal” is generally understood to mean a conversion of a halosilane-containing composition to the gas phase, by means of which the higher-boiling components or solids, such as hydrolysis products, can be removed, by virtue of the higher-boiling components preferably not being converted to the gas phase. Subsequently, a halosilane-containing composition is condensed to obtain, as the distillate, a prepurified composition II; correspondingly, the composition IIa_{1→∝}, can be obtained in the component step. This can be accomplished by means of tubular evaporators, thin-film evaporators, short-path evaporators and/or evaporation from a distillation receiver (still distillation). The distillation in the second process step is effected especially using a distillation column having at least one separating plate, though it is also possible to use columns having 1 to 150 plates.

The prepurified composition II relates to a composition with a boron content, especially of boron-containing compounds such as boron trichloride, hydrolyzed boron- and/or boron- and silicon-containing compounds, has been reduced by 20 to 99% by weight compared to composition I; more particularly, the boron content has been reduced by 50 to 99% by weight, but preferably by 70 to 99% by weight, 80 to 99% by weight and more preferably by 90 to 99% by weight. Expressed in mg/kg, the boron content is only ≦1.5 mg/kg in composition II, especially ≦1 mg/kg (ppm), preferably below ≦0.9 mg/kg (ppm). The boron still present may be present essentially in the form of volatile boron trichloride. In addition, composition II comprises preferably tetrachlorosilane, trichlorosilane, dichlorosilane and/or monochlorosilane, especially as a mixture; for removal of comparatively volatile components, such as hydrogen and/or hydrochloride, the composition II may be sent to a condensation.

According to the invention, composition II, optionally after a condensation step, is contacted with a moist adsorbent in a third process step to obtain a prepurified composition III. Compared to composition II, composition III has a boron content reduced by 50 to 99.999% by weight, the reduction in the boron content being 80 to 99.999% by weight, 90 to 99.999% by weight and more preferably 95.00 to 99.999% by weight. Expressed in mg/kg or μg/kg, it is possible to attain a boron content of less than 0.1 mg/kg, especially of ≦0.05 mg/kg, preferably of ≦0.01 mg/kg (ppm) and more preferably of ≦5 μg/kg, micrograms of boron per kilogram of composition III.

In relation to composition I, the prepurified composition III may have a boron content reduced by 99.00 to 99.9999% by weight, the aim being a reduction in the content of at least 99.00 to 99.999% by weight, preferably of at least 99.50 to 99.9999% by weight or higher.

According to the invention, the composition III obtainable by the process is sent to a fine distillation in order to isolate at least one ultrahigh-purity silicon compound. These compounds are in particular halosilanes or silicon halides, such as tetrachlorosilane, trichlorosilane, dichlorosilane, monochlorosilane, monosilane, disilane and/or else hexachlorodisilane. Preference is given to isolating ultrahigh-purity monosilicon compounds such as tetrachlorosilane, trichlorosilane, dichlorosilane, etc. The ultrahigh-purity silicon compounds isolated after the fine distillation each have a content of impurities of ≦50 micrograms per kilogram of silicon compound, especially of ≦25 μg/kg (ppb), preferably of ≦10 μg/kg (ppb), more preferably of ≦5 μg/kg (ppb) or ≦1 μg/kg (ppb), per silicon compound.

Process steps one, the component step of recycling, and/or the second process step can be connected singly or multiply in series, or passed through in a plurality of cycles, and/or the process steps connected singly or multiply in series may additionally run in parallel in the process. More particularly, process steps one and two may be passed through completely or partially in at least one cycle; preference is given to passing through a multitude of cycles. For this purpose, an apparatus (1) and the distillation unit (2) may be integrated together in one unit. The process according to the invention is preferably integrated in an overall process for preparation of ultrahigh-purity silicon compounds, proceeding from a hydrohalogenation or halogenation of metallurgical silicon.

In the process according to the invention, the prepurified composition II is contacted with a moist adsorbent in a third step to obtain a prepurified composition III. In this third process step, the composition II, ideally in plug flow, flows through the adsorbent without significant backmixing as a result of turbulent flow. Also conceivable, however, is mere passage over the absorbent. Generally, the composition II can be contacted in the third process step in the liquid or gaseous phase with the moist adsorbent. After the contacting, the prepurified composition III can likewise be obtained in the gaseous or liquid phase. The contacting with the moist adsorbent can be effected continuously or else batchwise. In the case of batchwise conversion, the composition II can, for example, be left to stand or stirred with the adsorbent. Typically, the prepurified composition II is contacted with the adsorbent at a temperature in the range from −30° C. to 100° C. and a pressure in the range from 0.5 to 20 bar_{abs.}, or flowing with the adsorbent within this temperature and/or pressure range and a space velocity of 0.01 to 20 liters/hour. Typical contact times are 0.1 to 20 hours, preferably 0.5 to 5 hours.

The adsorbent used may advantageously, but not exclusively, be a precipitated or fumed silica, a silica gel, a zeolite, a resin and/or an activated carbon, the person skilled in the art being aware that it is generally possible to use all materials on whose inner or outer surfaces water or compounds containing hydroxyl groups can add on, and can then react with the boron-containing compounds. In general, the adsorbent is used in particulate or extruded form, in which case the fine particulate adsorbent may be present with particle sizes in the range from 0.5 to 500 μm, or the extruded adsorbent with particle sizes in the range from 0.5 to 10 mm. The adsorbent preferably has a virtually homogeneous particle size, in order that a sufficient volume is available between the particles for passage of the composition II. Generally, the adsorbent may be in the form of powders, shaped bodies or extrudates.

According to the invention, the moist adsorbent has a chemical moisture content in the range from 0.1 to 10% by weight, especially in the range from 1 to 5% by weight (±0.2% by weight), and/or a physical moisture content in the range from 0.1 to 10% by weight, especially in the range from 0.1 to 1% by weight (±0.1% by weight). The physical moisture content is determined by determining the drying loss of the adsorbent at 105° C. over 2 hours, and the chemical moisture content is found by subsequently determining the ignition loss at 1000° C. over 2 hours.

In order to contact the adsorbent with the composition II, it may be present in the form of at least one adsorption bed in a fixed bed tubular reactor, in an adsorption column or on trays or separating plates of an adsorption or distillation column, or in a tank reactor as an adsorption bed, especially in particulate and/or extruded form. In the case of initial charging of the adsorbent in a tank reactor, this may be a stirred tank reactor.

When the adsorbent is present on at least one separating plate of a distillation column, this column may, in accordance with the invention, comprise two regions.

a) In one alternative, the composition I which has been contacted with moisture and/or the composition IIa_{1→∝} can first be removed, in a first region of the column, at least partly from hydrolyzed boron and/or silicon compounds. This first region may be followed by a second region of the column, in which the moist adsorbent can be contacted with the resulting composition II in order to obtain the prepurified composition III.

b) In a further alternative, in a third region of the column, this may be directly followed by the fine distillation of the prepurified composition III in order to obtain at least one ultrahigh-purity silicon compound.

In a further alternative, c), the column comprises a first region in which the moist adsorbent can be contacted with the prepurified composition II, and the resulting prepurified composition III can then be subjected in a second region of the column to a fine distillation in order to obtain at least one ultrahigh-purity silicon compound. This column may be connected in parallel with further corresponding columns.

In the case of use of a customary moist adsorbent, for example undried Aeroperl®300/30 with a loading capacity of about 1 mg_{boron}/g_{Aeroper®300/30}, it would be possible, by the combination of process steps one, optionally of the component step, and of process steps two and three, to enhance the average service life of an adsorbent by two to 25 times with the same loading capacity, preferably by 5 to 15 times. Generally, the service life, however, depends on many factors, such as the internal and external surface area, the flow of the compounds, number of reactive positions, etc.

In the case of conversion to a customary industrial scale of 2 t/h of chlorosilane with an inlet concentration of 5 mg/kg of boron, which is being passed through 3 t of Aeroperl®300/30, the service life until breakthrough, i.e. an outlet concentration of boron after contact with the adsorbent of >0.05 mg/kg, would be only 12.5 days. By virtue of the combination of process steps one, and the optionally performed component step, and of process steps two and three, the service life at an inlet concentration of 0.5 mg/kg into the adsorption unit can be increased to 125 days, or alternatively the adsorption unit can be designed with a significantly lower volume and less adsorbent.

The ultrahigh-purity silicon compound may comprise a single halogen compound (silicon halide) or else a mixture of halosilanes (silicon halides). These are in particular tetrachlorosilane, trichlorosilane, dichlorosilane, monochlorosilane, hexachlorodisilane, tetrabromosilane, tribromosilane, dibromosilane, and further halosilanes (silicon halides) formed. The prepurified composition III is preferably subjected to a fractional fine distillation in order to isolate at least one ultrahigh-purity monosilicon compound such as ultrahigh-purity tetrachlorosilane, trichlorosilane and/or dichlorosilane. An ultrahigh-purity silicon compound, especially after fine distillation, has a boron content of ≦50 micrograms per kilogram (ppb) of silicon compound, it being possible to attain contents of ≦50 μg/kg (ppb), especially of ≦25 μg/kg (ppb), preferably of ≦10 μg/kg (ppb) and more preferably of ≦5 μg/kg (ppb) or ≦1 μg/kg (ppb) of boron per kilogram of the ultrahigh-purity silicon compound.

In addition to a reduction in the boron content, it is also possible to reduce the contents of further impurities, such as especially those of aluminum compounds, iron compounds, arsenic compounds, magnesium compounds and/or phosphorus compounds. For example, the content of the individual impurities in the prepurified composition III may be reduced by ≧5% by weight in relation to the composition I; preference is given to attaining a content reduced by 5 to 99.9% by weight in each case.

The invention further provides for deposition of the ultrahigh-purity silicon compounds, such as the ultrahigh-purity trichlorosilane and/or tetrachlorosilane, optionally in the presence of hydrogen, to give ultrahigh-purity silicon. This can be accomplished, for example, by thermal decomposition of trichlorosilane on a hot substrate in the presence of hydrogen. The decomposition temperatures may be 800 to 1300° C. This is typically accomplished by the CVD (chemical vapor deposition) method. One alternative is the deposition of tetrachlorosilane/hydrogen mixtures in a capacitatively coupled plasma for deposition of silicon on hot surfaces. A further method may be a conversion of the ultrahigh-purity halosilanes by a plasma discharge to obtain polysilanes, which can subsequently be converted to ultrahigh-purity silicon in the presence of hydrogen at, for example, 900° C. The ultrahigh-purity halosilanes obtained by the process according to the invention enable production of ultrahigh-purity silicon, especially with a purity considering all impurities of ≦1 microgram/kilogram of silicon (μg/kg or ppb), which is outstandingly suitable for use in semiconductor production and for production of wafers in photovoltaic systems. The starting material for light waveguides is generally high-purity SiO₂, for the production of which high-purity or even ultrahigh-purity SiCl₄ is suitably likewise used.

The invention further provides for the conversion of ultrahigh-purity tetrachlorosilane, ultrahigh-purity trichlorosilane and/or ultrahigh-purity dichlorosilane to ultrahigh-purity monosilane. The ultrahigh-purity monosilane (a) can be prepared from ultrahigh-purity tetrachlorosilane, trichlorosilane and/or dichlorosilane by disproportionation. Monosilane is preferably prepared by disproportionation of a trichlorosilane-containing halosilane stream, which also forms tetrachlorosilane. The disproportionation is effected typically over catalytically active solids known per se to those skilled in the art, under a pressure of 400 mbar to 55 bar. Catalytically active solids are finely divided transition metals or transition metal compounds from the group of nickel, copper, iron, cobalt, molybdenum, palladium, platinum, rhenium, cerium and lanthanum; see also EP 0 658 359 A2. The catalytically active solid used may equally also comprise metals or metal salts from the group of elements of main group 2 of the periodic table of the elements. These may be calcium, strontium, barium, calcium chloride and/or strontium chloride; see also WO 05/102927. It is likewise possible to use, as catalytically active solids, basic solids, especially basic ion exchange resins, as disclosed, for example, by WO 06/029930 and the literature cited therein. The resulting monosilane is condensed in a plurality of condensation steps at temperatures of −40° C. to 50° C. An ultrahigh-purity monosilane obtained via condensation steps and/or distillation steps can subsequently be converted to ultrapure silicon by thermal decomposition, especially to ultrahigh-purity epitactic layers. Ultrahigh-purity monosilane can also be converted in the presence of ammonia to silicon nitride (Si₃N₄), or in the presence of dinitrogen monoxide (N₂O) to silicon oxinitride (Si₂N₂O₉) .

It is likewise possible to prepare ultrahigh-purity silicon dioxide from the ultrahigh-purity tetrachlorosilane in the presence of oxygen; this is typically accomplished at temperatures around 1800° C. in an oxygen stream. The silicon dioxide formed can be used to produce light waveguides, since only ultrahigh-purity silicon dioxide has the necessary transparency to conduct light over long distances without loss.

The present invention further provides production of the composition I which comprises at least one silicon halide and is used in the process according to the invention by:

a) Reaction of metallurgical silicon with hydrogen chloride. In general, this metallurgical silicon has a purity of 98-99% by weight. As a result of the conversion of the metallurgical silicon, the preparation-related impurities are halogenated, and impurities, for example AlCl₃, FeCl₂, BCl₃ or else phosphorus-containing compounds, are prepared, which have to be removed in downstream process stages in order to obtain an ultrahigh-purity halosilane (ultrahigh-purity silicon halide) or from these prepared silicon compounds or ultrapure silicon.

Also b) the reaction of metallurgical silicon in the presence of hydrogen chloride and tetrachlorosilane or

c) the reaction of metallurgical silicon in the presence of hydrogen, hydrogen chloride and tetrachlorosilane.

A common feature of processes a) to c) is that each is effected in a fluidized bed reactor, fixed bed reactor or rotary tube furnace at a temperature in the range from 400 to 800° C. and a pressure in the range from 20 to 45 bar, optionally in the presence of a catalyst, the reaction a), b) or c) optionally being followed by sending the crude gas stream to scrubbing with condensed chlorosilanes, or quenching thereof. The scrubbing is effected preferably in a distillation column with 3 to 100 plates at a pressure of 20 to 45 bar and a temperature in the range from 150° C. to 230° C.; subsequently, it is possible to isolate a composition I which can be sent to the process according to the invention to reduce the boron content. The compositions I obtained from the reaction of metallurgical silicon comprise essentially trichlorosilane, i.e. the trichlorosilane content is generally in the range from 50 to 99% by weight, but is dependent on the reactor type, for example for a fluidized bed: 80% trichlorosilane and 20% tetrachlorosilane, and for a fixed bed: 20% trichlorosilane and 80% tetrachlorosilane. The composition I is preferably not sent to any further distillation for separation of the halosilanes before the reduction of the boron content.

The process according to the invention and the inventive plant are illustrated hereinafter with reference to the schematic diagrams reproduced in the figures.

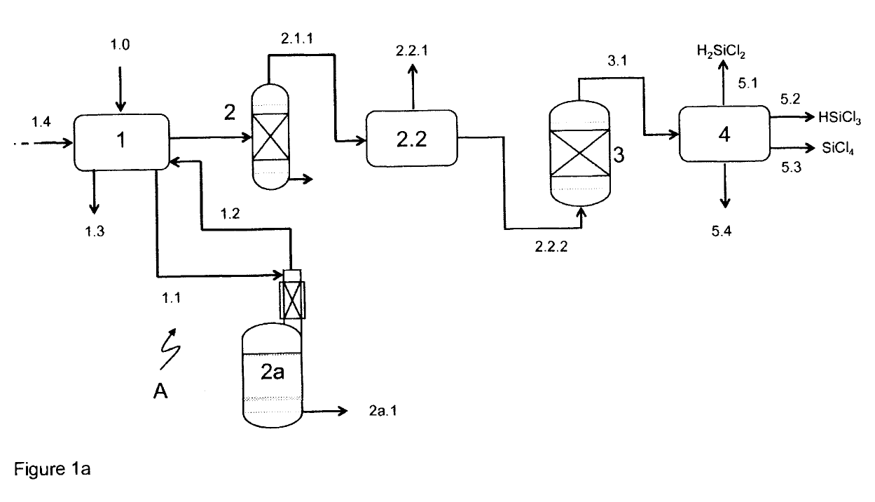

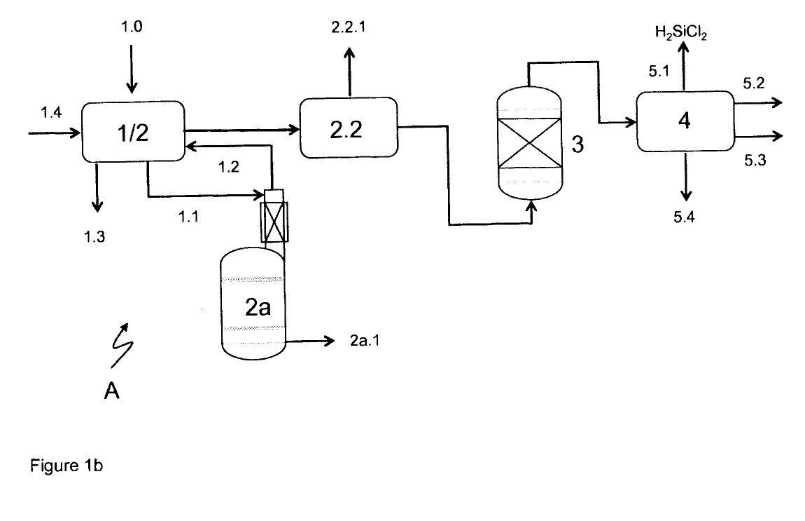

FIG. 1a: Schematic diagram of the process according to the invention in an inventive plant (A).

FIG. 1b: Alternative schematic diagram of the process in an alternative plant (A).

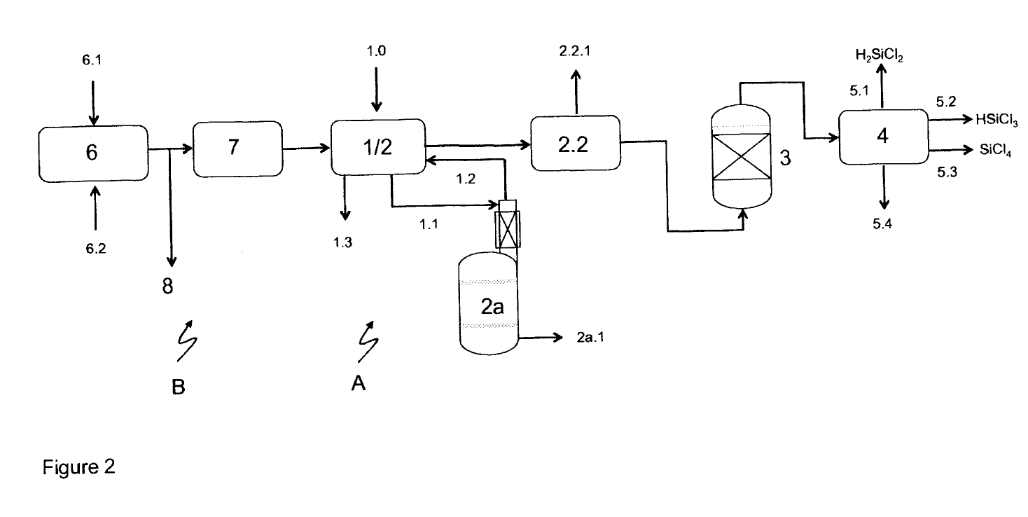

FIG. 2: Schematic diagram of an inventive plant comprising the plant (A) and the component plant (B).

According to the invention, the process is performed in such a way that the composition I (1.4) (see FIG. 1a) is contacted with moisture (1.0), especially with up to 600 mg/kg, optional repeated performance of the component step (1.1, 2a, 2a.1, 1.2), and removal of the hydrolyzed boron- and/or silicon-containing compounds (2; 1.3 and optionally 2a.1), and optionally subsequent contacting of the composition II obtainable (2.1.1; 2.2.2) with a moist adsorbent (3) in order to obtain a composition III (3.1). These process steps are more preferably effected in an integrated manner before a fractional fine distillation (4) in an overall process for preparation of ultrahigh-purity halosilanes (FIG. 2); the process according to the invention is more preferably integrated into an overall process for preparing ultrahigh-purity silicon, ultrahigh-purity monosilane (SiH₄), ultrahigh-purity silicon dioxide (SiO₂), silicon nitride, silicon oxynitride, and/or for preparation of organofunctional silanes, such as adhesion promoters. It is more preferably integrated into an overall process for production of ultrahigh-purity silicon proceeding from metallurgical silicon.

The efficiency of the process according to the invention (FIG. 1a/b) is particularly efficient when the contacting (feeding of moisture) is effected in an evaporation apparatus (1), which may be a tubular evaporator or a tank (reactor), for example a heatable tank reactor. The moisture (1.0) is added as a moisture feed preferably via an inert gas, such as moist nitrogen. In this case, for example, demineralized water is provided by means of a reservoir under pressure (nitrogen), and the mixture is homogenized by means of an evaporator and superheated to more than 100° C. with absolute freedom from droplets. The demineralized water and the nitrogen can each be added via ultrafine regulators, and they are supplied under elevated pressure to the composition I. The composition I is, for example, flashed into a tank and evaporated in one stage. A liquid and gaseous phase of the composition I is then present in the tank (1). The tank may be connected to a condensation column (2) having at least one separating plate, in which a portion of the composition I which has been contacted with moisture flows back again as a return stream.

The process according to the invention allows the amounts of moisture added (1.0) to be kept particularly small, such that there is no pronounced silicification in the plant components. The relatively high-boiling boron complexes formed, such as Cl₂B—O—SiCl₂H or Cl₂B—O—SiCl₃ by a partial hydrolysis of trichlorosilane or tetrachlorosilane, can be enriched in the distillation still (bottoms) in the subsequent distillation (2 and/or 2.a), in which only a small number of separating plates is needed.

HSiCl₃+H₂O→HSi(OH)Cl₂+HCl

BCl₃+HSi(OH)Cl₂43 Cl₂B—O—SiCl₂+HCl

SiCl₄+H₂O→Si(OH)Cl₃+HCl

BCl₃+Si(OH)Cl₃Cl→Cl₂B—O—SiCl₃+HCl

The halosilanes condensed after the distillation step (composition II, 2.1.1, 2.2.2) generally still contain volatile unconverted boron trichloride; they are contacted together with a moist adsorbent, by, for example, passing them through an adsorption unit (3, adsorber) with moist silica. Plug flow is preferably attained, without backmixing as a result of swirl formation. The customary contact times are 0.1 to 20 hours, preference being given to 0.5 to 5 hours.

According to the invention, a high degree of purification of the composition II is attained when the proportion of Si—OH groups of the silica is high, in order that chemical binding of the boron-containing impurities can proceed (chemisorption); see Morrow B. A., McFarlan A. J.; Chemical Reactions at Silica surfaces (Journal of Non-Crystalline solids, 120 (1990), 61-71).

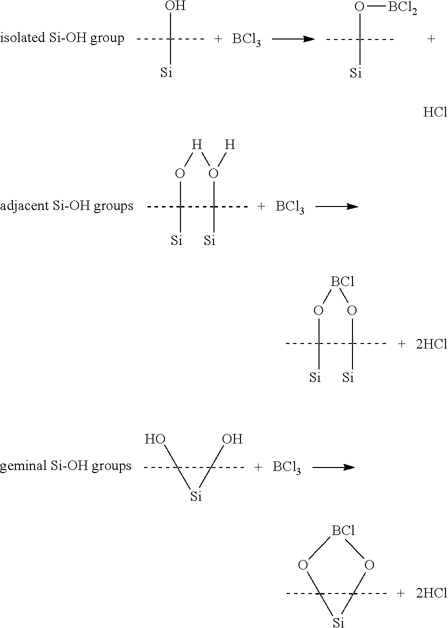

As a result of the formation of a chemical bond with the boron-containing impurities and further impurities, no further purification step is needed, more particularly no further separating option for removal of the impurities. Owing to the significantly lower inlet concentration of boron-containing compounds, this step becomes particularly efficient by virtue of an upstream connection of moisture feeding and removal of the hydrolyzed boron- and/or silicon-containing compounds.

By virtue of this inventive combination of the two steps, comprising the contacting of composition I with moisture, optionally at least single performance of the component step, removal of composition II and contacting of composition II with a moist absorbent, the boron contents, especially of boron-containing impurities, are already brought to a very low level by the first “coarse purification” if the composition II is contacted with the adsorbent.

The combination of these process steps increases the service lives of the adsorbents to a quite considerable degree, while at the same time allowing a distinct reduction in silicification of the plant components in the first process step, since it is possible to work with a very much lower concentration of moisture in the first process step. Equally, the process enables a constant low content of boron in the overall product stream, and hence also in the product streams obtained after the fine distillation, including, for example, tetrachlorosilane, trichlorosilane, dichlorosilane, etc.

The invention also provides a plant (A) comprising an apparatus (1) with an assigned distillation unit (2), wherein the apparatus (1) and the distillation unit (2) may be integrated in the apparatus (1) (FIG. 1b), wherein the apparatus (1) optionally has an assigned separation unit (2a), especially with an assigned column, wherein a stream can be conducted in a cycle (1.1; 1.2), the distillation unit (2) additionally has an assigned condensation unit (2.2) for partial condensation of composition II (2.1.1), and especially for removal of volatile gases (2.2.1), such as H₂ or hydrochloride, an adsorption unit (3) assigned to the condensation unit (2.2) is arranged downstream, wherein a distillation unit (4) for fine distillation of the composition III (3.1) assigned to the adsorption unit (3) is arranged downstream, the distillation unit (4) has at least one assigned product withdrawal point (5.1, 5.2, 5.3), especially for withdrawal of low boilers such as H₂SiCl₂, HSiCl₃ and/or SiCl₄, and an assigned withdrawal point (5.4) for withdrawal of high boilers, polymeric halosilanes and/or high-boiling impurities. The distillation unit (2a) comprises an evaporator and/or a column, especially for flash distillation.

The apparatus for feeding in moisture (1) preferably has a tank (reactor), a tubular evaporator, a plate evaporator and/or a column which works by the countercurrent principle, or an apparatus with a similar effect, and at least one fine regulator for addition of the moisture (1.0). The composition I can be supplied via a reactant supply (1.4). Solids and/or high-boiling compounds can be drawn off continuously or batchwise (1.3) (FIGS. 1a/b, 2).

The distillation unit (2) may comprise a column or else a plate condenser. Preference is given to a still distillation. The separation unit (2a) comprises especially a heatable tank or reactor and/or a heatable and/or coolable column for removal of hydrolyzed boron- and/or silicon-containing compounds.

The adsorption unit (3) may have at least one assigned adsorption bed in a fixed bed reactor, tubular reactor, in an adsorption column or the trays of an adsorption column. Alternatively, the adsorption unit (3) may have a tank reactor or a fluidized bed reactor with an adsorbent. The adsorption unit (3) preferably has, as an adsorption bed or adsorbent, at least one precipitated or fumed silica, a silica gel, a zeolite, a resin and/or an activated carbon, which may be in particulate or extruded form, and which may have the particle sizes and chemical and/or physical moisture contents already stated. The distillation unit (4) preferably comprises at least one rectification column.

Appropriately, the apparatus for feeding in the moisture (1) may be preceded upstream by a distillation unit (not shown) for fine distillation of the halosilanes; in this case, the separated halosilanes could each pass separately through the process according to the invention for reducing the boron content.

For performance of an overall process (FIG. 2), the plant (A) is assigned an upstream component plant (B), said component plant (B) having a reactor (6), especially a fluidized bed or fixed bed reactor or rotary tube furnace for reaction of metallurgical silicon (6.1) with hydrogen chloride, hydrogen and/or silicon tetrachloride (6.2); the reactor (6) is assigned a downstream apparatus (8) for deposition of particulate reaction products, for example of dust or solid metal chlorides, to which is assigned an apparatus (7) for scrubbing or for quenching the stream; in general, the apparatus for scrubbing comprises a multistage distillation column; it is possible here, as well as AlCl₃, also to remove any relatively high-boiling compounds present, such as disilanes, polysilanes, siloxanes and/or hydrocarbons from the crude gas stream of the metallurgical reaction, the apparatus (7) being assigned to the upstream apparatus (1) for feeding in moisture. The parts of the plant (A and/or B) which come into contact with the halosilanes are generally made from nickel-containing material, especially from nickel-containing steel.

The example which follows illustrates the process according to the invention in detail without restricting the invention to this example.

### EXAMPLE

Determination of boron content or that of other elements: The samples were prepared and the samples were analyzed in a manner familiar to the skilled analyst, by hydrolyzing the sample with demineralized water and treating the hydrolyzate with hydrofluoric acid (superpure) to eliminate silicon in the form of volatile silicon tetrafluoride. The residue was taken up in demineralized water, and the element content was determined by means of ICP-MS (ELAN 6000 Perkin Elmer).

### Example 1

980 g of a customary chlorosilane mixture which had been obtained from a hydrochlorinating operation on metallurgical silicon and contained about 80% by weight of trichlorosilane, about 20% by weight of tetrachlorosilane, traces of dichlorosilane and a boron content of 8.7 mg/kg were admixed with 200 mg/kg of demineralized water. After a reaction time of one hour, the reaction mixture was transferred to a distillation still with a stirrer (1.2 l) and a distillation was conducted. The distillate obtained was 888 g of chlorosilanes with a boron content of 0.82 mg/kg. The residue (52 g) consisted essentially of tetrachlorosilane and hydrolyzed boron-containing compounds, and the boron content was 248 mg/kg. In a downstream cold trap, 40 g of chlorosilane with a boron content of 0.07 mg/kg were retained.

Thereafter, the isolated distillate was passed through an adsorber filled with undried Aeroperl®300/30. The physical moisture content of the adsorbent was 3% by weight and was found via a drying loss at 105° C. for 2 hours. The chemical moisture content of the adsorbent was 1% by weight and was found via the ignition loss at 1000° C. over 2 hours. The residence time over the adsorbent was one hour. After the adsorption, the boron content in the product was below 0.01 mg/kg.

Using the example of the undried Aeroperl®300/30 used, the breakthrough curve was determined and gave a loading capacity of about 1 mg_{boron}/g_{Aeroperl®300/30}.

In the case of conversion to a customary industrial scale of 2 t/h of chlorosilane with an inlet concentration of 5 mg/kg of boron, which is passed through 3 t of Aeroperl®300/30, the service life until breakthrough, i.e. a starting concentration of boron after contact with the adsorbent of >0.05 mg/kg, would be only 12.5 days. By virtue of the combination of process steps one, and the optionally performed component step, and of process steps two and three, the service life at an inlet concentration of 0.5 mg/kg into the adsorption unit can be increased to 125 days, or alternatively the adsorption unit can be designed with a significantly lower volume and less adsorbent.

### List of reference numerals

A Plant A; B Component plant B;

1 Apparatus for feeding in moisture; 1.0 Moisture feed (H₂O), for example ultrafine regulator; 1.1 Line; 1.2 Line (composition IIa_{1→∝}); 1.3 Outlet (solids, high boilers); 1.4 Line (feed for composition I); Distillation unit; 2.1.1 Line (composition II);

2a Separation unit; 2a.1 Outlet (solids, B—O—Si compounds); 2.2 Condensation unit; 2.2.1 Outlet (hydrogen, hydrochloride, low boilers); 2.2.2 Line (composition II);

3 Adsorption unit/adsorbent, 3.1 Line (composition III);

4 Distillation unit; 5.1 Product withdrawal point (low boilers); 5.2 Product withdrawal point (low boilers);

5.3 Product withdrawal point (low boilers); 5.4 High boiler withdrawal point;

6 Reactor; 6.1 Feed of metallurgical silicon; 6.2 Feed (HCl or HCl, SiCl₄ and H₂),

7 Apparatus for scrubbing or for quenching;

8 Apparatus for deposition of particulate reaction products (dust, solid metal chlorides).

Literature:

1: Morrow B. A., McFarlan A. J.; Chemical Reactions at Silica surfaces (Journal of Non-Crystalline solids, 120 (1990), 61-71).

1. A process for reducing boron content in a composition I comprising at least one silicon halide, the process comprising:
(A) contacting the composition I with up to 600 mg of moisture per kilogram of the composition I, to give a moist composition I;
(B) optionally, subjecting the moist composition I at least once, completely or partially, to removing hydrolyzed boron-comprising and/or silicon-comprising compounds, to obtain a prepurified composition IIa_{1→∝}, which is completely or partially fed back to the step contacting or onward to (C) in the process; and
(C) removing the hydrolyzed boron-comprising and/or silicon-comprising compounds by distillation to obtain, as a distillate, a prepurified composition II with a reduced boron content.

2. The process according to claim 1, wherein the prepurified composition II still comprises volatile boron trichloride.

3. The process according to claim 1, wherein the prepurified composition II comprises tetrachlorosilane, trichlorosilane, dichlorosilane, and/or monochlorosilane.

4. The process according to claim 1, wherein the distillation in (C) is effected by a distillation column.

5. The process according to claim 1, wherein a moisture content of the moist composition I is 0.5 to 500 mg of water per kilogram of the composition I.

6. The process according to claim 5, wherein the moisture content is 5 to 100 mg of water per kilogram of the composition I.

7. The process according to claim 5, wherein the moisture content is 10 to 50 mg of water per kilogram of the composition I.

8. The process according to claim 1, wherein the contacting introduces a moisture content by an inert gas, which comprises moisture.

9. The process according to claim 1, further comprising:
(D) contacting the prepurified composition II with a moist adsorbent, to obtain a prepurified composition III.

10. The process according to claim 9, wherein a content of impurities comprising at least one aluminum compound, iron compound, arsenic compound, magnesium compound, and/or phosphorus compound in the prepurified composition III has been reduced ≧5% by weight in relation to the composition I.

11. The process according to claim 9, wherein the adsorbent is a precipitated silica, a fumed silica, a silica gel, a zeolite, a resin, and/or an activated carbon.

12. The process according to claim 9, wherein the adsorbent is in fine particulate or extruded form.

13. The process according to claim 12, wherein the adsorbent is in fine particulate form and has a particle size in a range from 0.5 to 500 μm, or
the extruded adsorbent is in extruded form and has a particle size in a range from 0.5 to 10 mm.

14. The process according to claim 9, wherein a chemical moisture content of the adsorbent is in a range from 0.1 to 10% by weight.

15. The process according to claim 14, wherein the chemical moisture content of the adsorbent is in a range from 1 to 5% by weight, ±0.2% by weight.

16. The process according to claim 9, wherein a physical moisture content of the adsorbent is in a range from 0.1 to 10% by weight.

17. The process according to claim 16, wherein the physical moisture content of the adsorbent is in a range from 0.1 to 1% by weight, ±0.1% by weight.

18. The process according to claim 9, wherein the prepurified composition II is in a liquid or gaseous phase when contacted with the moist adsorbent.

19. The process according to claim 9, wherein the prepurified composition II is contacted with the adsorbent at a temperature in a range from −30° C. to 100° C. and a pressure in a range from 0.5 to 20 bar_{abs}.

20. The process according to claim 9, wherein the prepurified composition II is contacted with the adsorbent flowing at a temperature in a range from −30° C. to 100° C. a pressure in a range from 0.5 to 20 bar_{abs}, and a space velocity of 0.01 to 20 liters/hour.

21. The process according to claim 9, wherein the prepurified composition II is contacted continuously or batchwise with the moist adsorbent.

22. The process according to claim 9, wherein the adsorbent is present as at least one adsorption bed in a fixed bed tubular reactor, in an adsorption column or on at least one tray in an adsorption column, or in a tank reactor as an adsorption bed, in particulate and/or extruded form.

23. The process according to claim 1, wherein the prepurified composition II has a boron content reduced by 20 to 99% by weight compared to the composition I.

24. The process according to claim 1, wherein the prepurified composition II has a boron content of ≦1.5 mg of boron per kilogram of composition II.

25. The process according to claim 9, wherein the prepurified composition III has a boron content reduced by 50 to 99.999% by weight compared to composition II.

26. The process according to claim 9, wherein the prepurified composition III has a boron content of less than 0.1 mg of boron per kilogram of composition III.

27. The process according to claim 9, wherein the prepurified composition III has a boron content reduced by 99.00 to 99.9999% by weight compared to the composition I.

28. The process according to claim 9, further comprising:
(E) subjecting the prepurified composition III to a fractional fine distillation in order to isolate at least one ultrahigh-purity silicon compound.

29. The process according to claim 28, wherein the at least one ultrahigh-purity monosilicon compound comprises ultrahigh-purity tetrachlorosilane, trichlorosilane, and/or dichlorosilane.

30. The process according to claim 28, wherein the at least one ultrahigh-purity silicon compound has a boron content of ≦50 micrograms per kilogram of the ultra-high purity silicon compound.

31. The process according to claim 29, wherein the ultrahigh-purity trichlorosilane and/or tetrachlorosilane is isolated and is optionally deposited in the presence of hydrogen to give ultrahigh-purity silicon.

32. The process according to claim 29, wherein ultrahigh-purity monosilane is prepared from the ultrahigh-purity tetrachlorosilane, ultrahigh-purity trichlorosilane, and/or ultrahigh-purity dichlorosilane, or ultrahigh-purity silicon dioxide from ultrahigh-purity tetrachlorosilane.

33. The process according to claim 32, wherein the monosilane is converted
thermally to ultrahigh-purity silicon, or
in the presence of ammonia, to silicon nitride, or
in the presence of dinitrogen monoxide, to silicon oxynitride.

34. The process according to claim 1, wherein the composition I comprising at least one silicon halide is prepared by reacting:
a) metallurgical silicon with hydrogen chloride or
b) metallurgical silicon in the presence of hydrogen chloride and tetrachlorosilane; or
c) metallurgical silicon in the presence of hydrogen, hydrogen chloride, and tetrachlorosilane,
in each case in a fluidized bed reactor, fixed bed reactor, or rotary tube furnace,
at a temperature in a range from 400 to 800° C. and
a pressure in a range from 20 to 45 bar,
optionally, in the presence of a catalyst,
the reacting a), b) or c) optionally being followed by subjecting the crude gas stream to scrubbing or quenching with condensed chlorosilanes in order to isolate the composition I.

35. A composition III, obtained according to claim 9.

36. An ultrahigh-purity silicon compound, obtained according to claim 28.

37. A plant, comprising:
a first apparatus with an assigned distillation unit, the first apparatus optionally comprising an assigned separation unit, wherein streams between the first apparatus and the separation unit are optionally conducted in a cycle;
a condensation unit assigned to the distillation unit, arranged downstream;
an adsorption unit assigned to the condensation unit, arranged downstream; and
a distillation unit for fine distillation assigned to the adsorption unit, arranged downstream, wherein the distillation unit has at least one product withdrawal point and a different withdrawal point.

38. The plant according to claim 37, wherein the first apparatus is for feeding in moisture and is a tank, a tank, a tubular evaporator, a plate evaporator, and/or a column which works by the countercurrent principle.

39. The plant according to claim 37, wherein the adsorption unit has comprises at least one assigned adsorption bed in a fixed bed reactor, tubular reactor, in an adsorption column or at least one tray of an adsorption column.

40. The plant according to claim 37, wherein the adsorption unit comprises a tank reactor, tubular reactor, tubular reactor, or a fluidized bed reactor with an adsorbent.

41. The plant according to claim 37, wherein the adsorption unit comprises, as an adsorption bed or adsorbent, at least one precipitated or fumed silica, a silica gel, a zeolite, a resin, and/or an activated carbon.

42. The plant according to claim 37, wherein the distillation unit comprises at least one rectification column.

43. The plant according to claim 37, wherein a plant component assigned to the plant is arranged upstream, and the plant component comprises:
(B) a reactor for reaction of metallurgical silicon with hydrogen chloride, hydrogen, and/or silicon tetrachloride;
a separating apparatus for separating out at least one particulate reaction product assigned to the reactor is arranged downstream of the (B) reactor,
a second apparatus for scrubbing and/or for quenching, assigned to said separating apparatus, and the second apparatus is assigned to the first apparatus for feeding in moisture and arranged upstream of the first apparatus.

44. A method of preparing at least one ultrahigh-purity silicon compound, comprising purifying
the prepurified composition II, obtained by the method of claim 1, or
a composition III, obtained by contacting the prepurified composition II with a moist adsorbent.
